(19) United States
(12) Patent Application Publication
(10) Pub. No.: US 2025/0116882 A1
(43) Pub. Date: Apr. 10, 2025

(54) DETACHABLE NOSE PADS

(71) Applicant: Hwa Meei Optical Co.,Ltd., Tainan (TW)

(72) Inventor: Chih-Ming Chen, Taiwan (TW)

(21) Appl. No.: 18/510,713

(22) Filed: Nov. 16, 2023

(30) Foreign Application Priority Data
Oct. 6, 2023 (TW) 112210861

(51) Int. Cl. G02C 5/12

(52) U.S. Cl. CPC G02C 5/126

(57) ABSTRACT

Provided is a pair of detachable nose pads, including a nose bridge holder and two nose pads. The nose bridge holder has corresponding mounting sections along both sides of a nose bridge of the wearer. Each of the mounting sections is provided with a slot and an insertion hole communicated with the slot. Each nose pad has a body and two brackets. An elastic space is formed between the two brackets, and a snap button protruded from the front end of the two brackets. and can be fixed in the slot When each of the nose pads is detached or inserted into the insertion hole, each of the two brackets can be deformed elastically to an elastic space by an external force such that the snap button is detached or forced into the slot, thereby improving the convenience of replacing nose pads.

### BACKGROUND OF THE INVENTION

### 1. Field of the Invention

The present disclosure relates eyeglasses nose pads, and particularly a structure of a pair of detachable nose pads that can be removed and replaced by oneself.

### 2. The Prior Arts

In addition to the temples of the eyeglasses, the nose pads are another important support element, and the structure of the nose pads can be categorized into fixed and movable types according to the type of eyeglasses.

Fixed nose pads are molded in one piece with the frame, and when the nose pads are damaged, it is not possible to separate the damaged nose pads for replacement such that the entire pair of eyeglasses must be discarded, which is wasteful and not environmentally friendly.

In addition, the movable nose pads are mainly screwed onto the bracket of the frame such that the screws can be used as the axis of the nose pads, which naturally oscillate up and down when touching the nose bridge so as to achieve support. When one of the movable nose pads is damaged, although it can be removed and replaced, it is still inconvenient to use tools to assist, therefore, there is still room for improvement in the structural design of the replacement of such nose pads.

### SUMMARY OF THE INVENTION

In view of the shortcomings and deficiencies of the prior art, the present disclosure provides a nose pad structure that is screwless and does not require tool-assisted disassembly.

In order to achieve the above purpose, the present disclosure provides a pair of detachable nose pads, which is fitted to a glasses, wherein a side facing a face of a wearer is defined as an inner surface and a side facing outside is defined as an outer surface, the par of detachable nose pads comprises: a nose bridge holder having a spanning section and mounting sections extending downwardly from both ends of the spanning section and disposed correspondingly along both sides of a nose bridge of the wearer, wherein each of the mounting sections is provided with a slot, the slot has a retaining surface, and an inner surface of each of the mounting sections is provided with an insertion hole connected to the slot; and two nose pads detachably embedded in each of the insertion holes, wherein each of the nose pads has a body that contacts with the wearer's nose to form a support, two brackets extend from one side of the body and penetrates through the insertion holes, the two brackets form an elastic space, a front end of each of the two brackets is radially projected with a snap button, a bottom of the snap button is fixed on a retaining surface of the slot.

According to the present disclosure, when each of the nose pads is detached or inserted into the insertion hole, each of the two brackets is deformed elastically by an external force into an elastic space such that the snap button is detached or forced into the slot. As such, the present disclosure allows the wearer to remove and replace the nose pads without the aid of tools, thereby enhancing the convenience of replacing the nose pads and helping to increase the environmental benefits.

### BRIEF DESCRIPTION OF THE DRAWINGS

FIG. 1 is a three-dimensional schematic diagram showing a pair of detachable nose pads of the present disclosure.

FIG. 2 is an exploded schematic diagram showing the pair of detachable nose pads of the present disclosure.

FIG. 3 is a partial exploded schematic diagram and its partial enlargement showing the pair of detachable nose pads of the present disclosure.

FIG. 4 and FIG. 5 are schematic diagrams showing the assembly and continuous operation according to the present disclosure.

FIG. 6 and FIG. 7 are schematic diagram showing the disassembled and continuous operation according to the present disclosure.

FIG. 8 is an exploded schematic diagram showing a nose pad according to one embodiment of the present disclosure.

FIG. 9 is a three-dimensional schematic diagram of FIG. 8.

FIG. 10 is a schematic diagram showing the pair of detachable nose pads on a frame according to one embodiment of the present disclosure.

FIG. 11 is a schematic diagram showing the pair of detachable nose pads on a lens according to another embodiment of the present disclosure.

### DETAILED DESCRIPTION OF THE PREFERRED EMBODIMENT

The following is a specific embodiment to illustrate the implementation of the present disclosure. Persons skilled in the art can easily understand the other advantages and effects of the present disclosure from the disclosure in the specification.

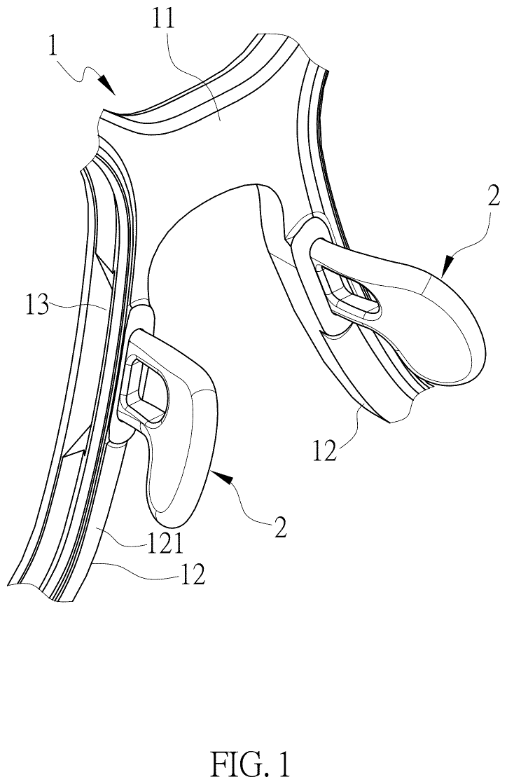

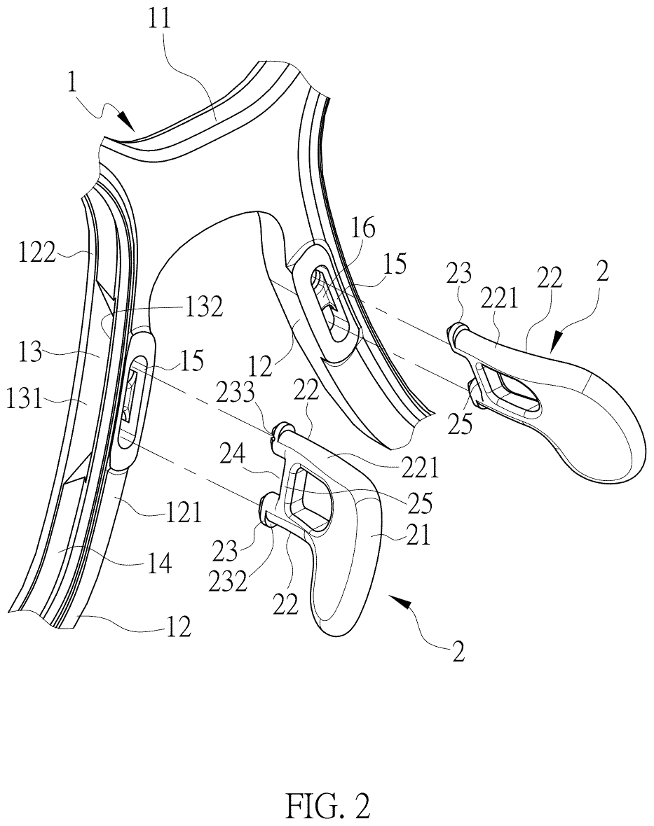

Referring to FIG. 1 to FIG. 3, a pair of detachable nose pads is shown. In the present disclosure, a side facing a face of a wearer is defined as an inner surface, and a side facing outside is defined as an outer surface. The present disclosure mainly includes a nose bridge holder 1 and two nose pads 2.

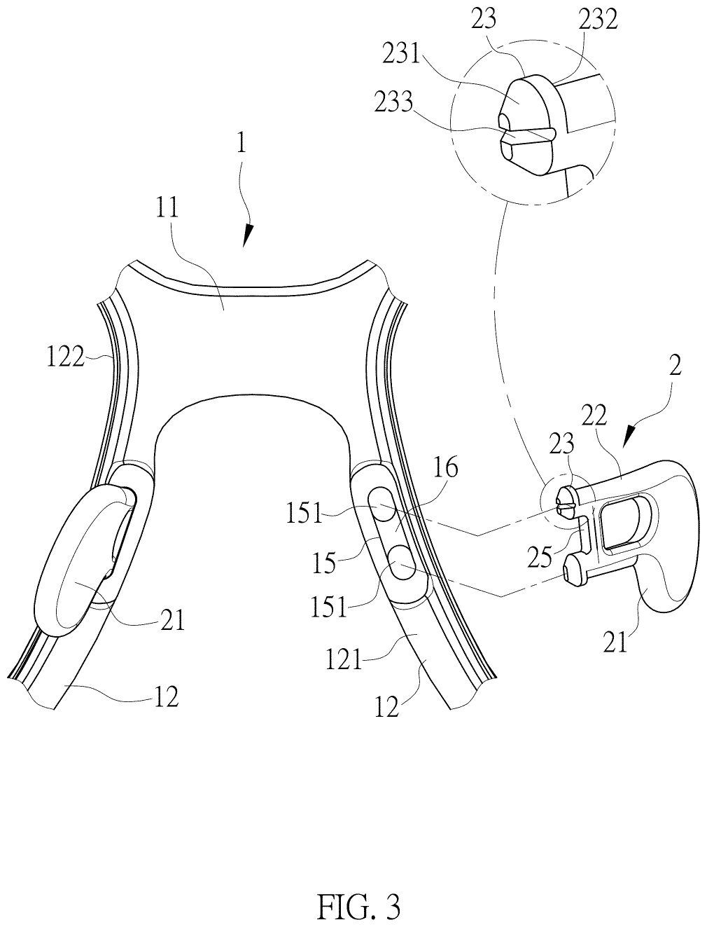

The nose bridge holder 1 has a spanning section 11 that spans over the bridge of the wearer's nose and a mounting section 12 that extends downwardly from both ends of the spanning section 11 and is disposed in a structurally symmetrical manner along both sides of the nose bridge of the wearer. Each of the mounting section 12 is provided with a slot 13 internally. One of the slot walls of the slot 13 forms a retaining surface 132. Each of the slots 13 has an opening 131 through the outer surface 122 of each of the mounting sections 12, and the outer side surface 122 of each of the mounting sections 12 is recessed with a lens groove 14 for accommodating a lens. Each of the mounting sections 12 is provided with an insertion hole 15, which runs from the inner surface 121 of the mounting section 12 to the retaining surface 132 and communicates with the slot 13. In an embodiment, each of the insertion holes 15 is in the form of a long strip from top to bottom along the length of the mounting section 12 as shown in FIG. 3, but not limited thereto.

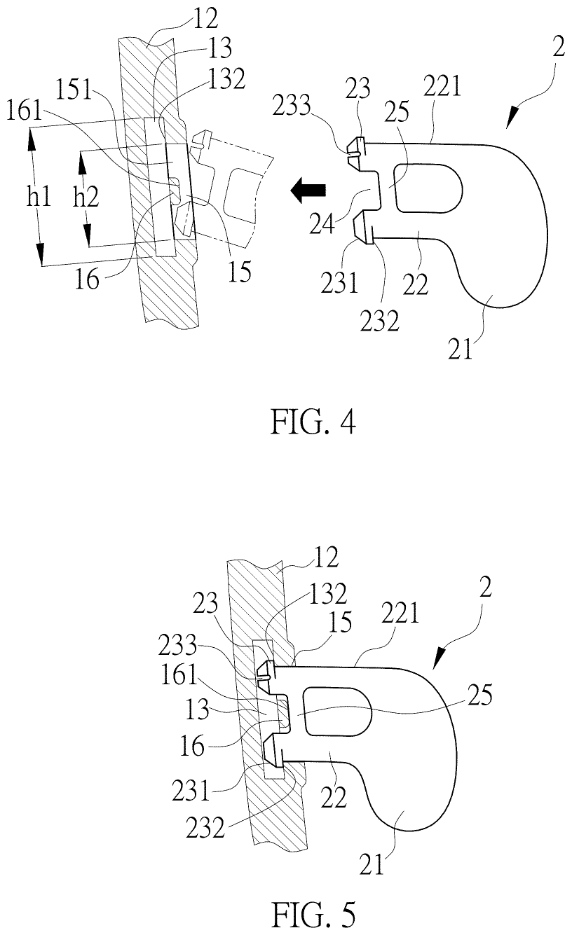

Referring to FIG. 4, the length h1 of each of the slots 13 is slightly larger than the length h2 of each of the insertion holes 15, and a stop portion 16 is provided at the middle of each of the insertion holes 15. In an embodiment, the stop portion 16 is provided from the retaining surface 132 of the slot 13 towards the inner surface 121 of the mounting section 12. In an embodiment, the top surface 161 of the stop portion 16 is lower than the inner surface 121 of the mounting section 12, and partially divides the insertion hole 15 into two sub-channels 151, but not limited thereto. In addition, the top surface 161 of the stop portion 16 may also be flush with or higher than the inner surface 121.

Each of the nose pads 2 has a body 21 and two brackets 22. The body 21 is in the shape of a curved piece which can contact with both sides of the wearer's nose to form a support. The two brackets 22 extend from one side of the body 21 and are arranged in an upward and downward manner, and the front end of each of two brackets 22 is radially projected with a snap button 23, the abovementioned radial direction refers to the direction of the outer diameter of the brackets 22. In an embodiment, each of the snap buttons 23 is projected towards the outer surface 221 of the brackets 22. Each of the snap buttons 23 has a tapering guiding surface 231, which may be curved or beveled. The illustration in the present disclosure is based on the example of beveled surface. The snap button 23 of one of the brackets 22 is recessed with a recess 233. In an embodiment, the recess 233 is located at the top of the snap button 23 of the bracket 22, and the recess 233 is recessed from the top of the snap button 23 to the bottom of the guiding surface 231 such that the guiding surface 231 at the top of the snap button 23 is formed in a partially enlarged state as shown in FIG. 3. The recess is formed into a compressed space. Also, an elastic space 24 is formed between the two brackets 22, and a reinforcing rib 25 is provided between the two brackets 22 to form a structural support between the two brackets 22 in the interval of the snap button 23.

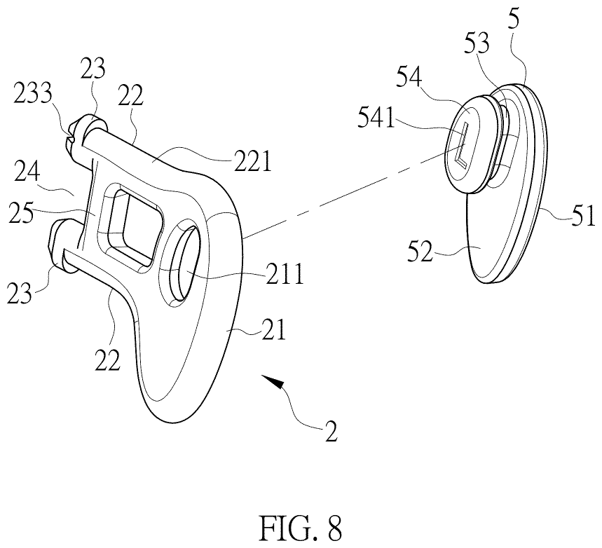

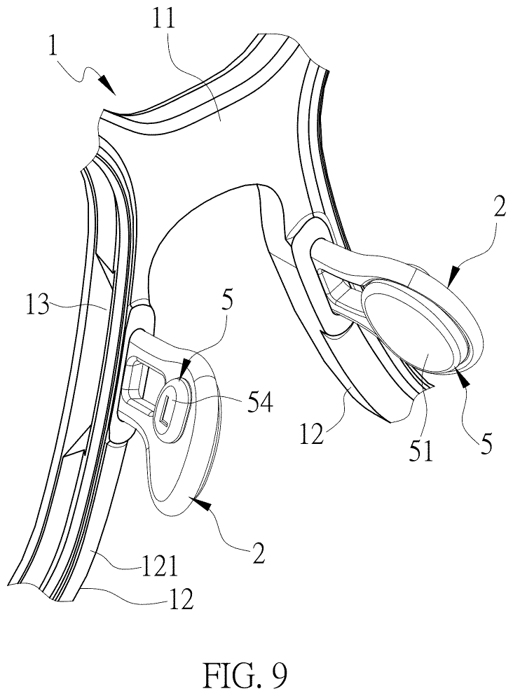

Continuing to refer to FIG. 8 and FIG. 9, in order to enhance the comfort of wearing the eyewear, in an embodiment, there are two cushions 5. Each of the cushions 5 has a contact surface 51 and a composite surface 52 separated from each other. The contact surface 51 corresponds to the sides of the wearer's nose. The composite surface 52 extends from a neck 53, and a plug 54 is provided at the end of the neck 53. The peripheral edge of the plug 54 is larger than the peripheral of the neck 53, and each of the body 21 is provided with a through-hole 211 on both sides of the wearer's nose. The shape of the through-hole 211 is matched to the neck 53. Each of the cushions 5 is forced into the through-hole 211 by the plug 54 such that the neck 53 is threaded through that through-hole 211. Additionally, each of the cushions 5 is affixed to the side of the body 21 facing the wearer, and one side of the plug 54 is against the other side of the body 21 such that each of the cushions 5 forms a cushioning effect, thereby enhancing the wearing comfort. Further, when each of the cushions 5 is directional, a symbol 541 may be provided on one side of each of the plugs 54 as a distinction between the left and right sides to avoid incorrect installation of each of the cushions 5.

Continuing to refer to FIG. 4 and FIG. 5, each of the nose pads 2 can be embedded in the insertion hole 15 by the two brackets 22 at the same time, and the two brackets 22 can be pushed by an external force (in the direction of the solid arrow in FIG. 4) and the nose pad 2 can be quickly forced into the insertion hole 15 by the guidance of the guiding surfaces 231 of each of the snap buttons 23. The two brackets 22 and each of the snap buttons 23 are elastically deformed toward the elastic space 24. Moreover, after each of the snap buttons 23 passes through each of the sub-channels 151, it elastically returns such that the bottom 232 of each of the snap buttons 23 is fixed on the retaining surface 132 of the slot 13. In addition, for each nose pad 2, as shown in FIG. 4, each snap button 23 of the lower bracket 22 can first be inserted into the slot 13, and then each snap button 23 of the upper bracket 22 can be inserted into the slot 13 to complete the setting. The upper bracket 22 is focred to elastically deform in the elastic space 24, and the recess 233 also provides a compressed space during deformation, thereby making it easier to assemble the snap buttons 23 of each nose pad 2. At the same time, each of the reinforcing ribs 25 is partially accommodated in each of the insertion holes 15, and can limit the left and right, up and down displacement of the nose pad 2 relative to the nose bridge holder 1. Also, by the reinforcing rib 25 abutting the stop portion 16 and the snap buttons 23 being fixed in the slot 13, the nose pad 2 is restricted relative to the nose bridge holder 1 to enable the nose pad 2 to be firmly placed on the nose bridge holder 1. It is worth mentioning that the two brackets 22 and the reinforcement ribs 25 match the shape of the insertion holes 15 and can be securely confined in the insertion holes 15, so as to improve the problem of the nose pads 2 being deflected outwardly by the force of downward compression when the eyeglasses are worn on the face.

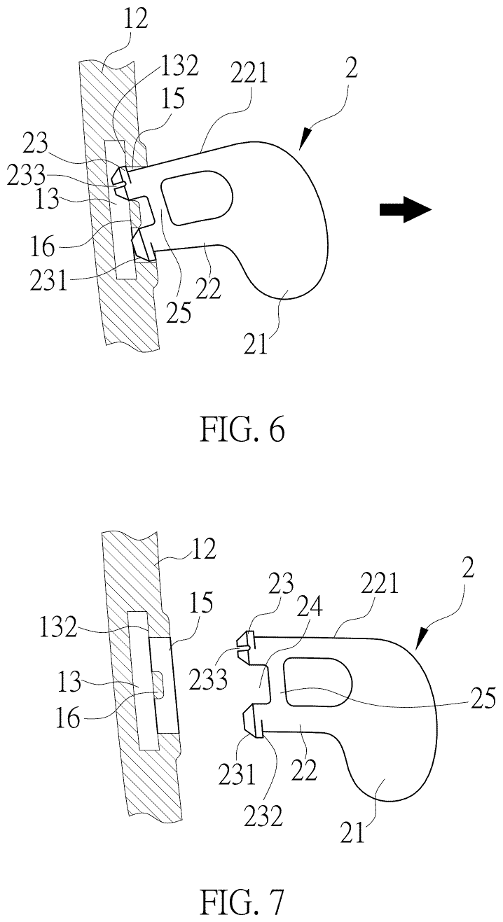

Continuing to refer to FIG. 6 and FIG. 7, when the nose pad 2 is to be replaced, only the nose pad 2 is to be applied in the reverse direction (the direction of the solid arrow in FIG. 6), and it is also possible to withdraw the snap button 23 of one of the brackets 22 from the slot 13 as described above, and then withdraw the other one from the other bracket 22, as indicated in FIG. 6, which indicates the withdrawal of the snap button 23 of the lower bracket 22, but not limited thereto. It is also possible to withdraw the snap button 23 of the upper bracket 22 first, allowing the snap button 23 and the two brackets 22 to elastically deform toward the elastic space 24 such that each of the snap buttons 23 is detached from the slot 13 and each sub-channel 151, and the nose pad 2 is replaced.

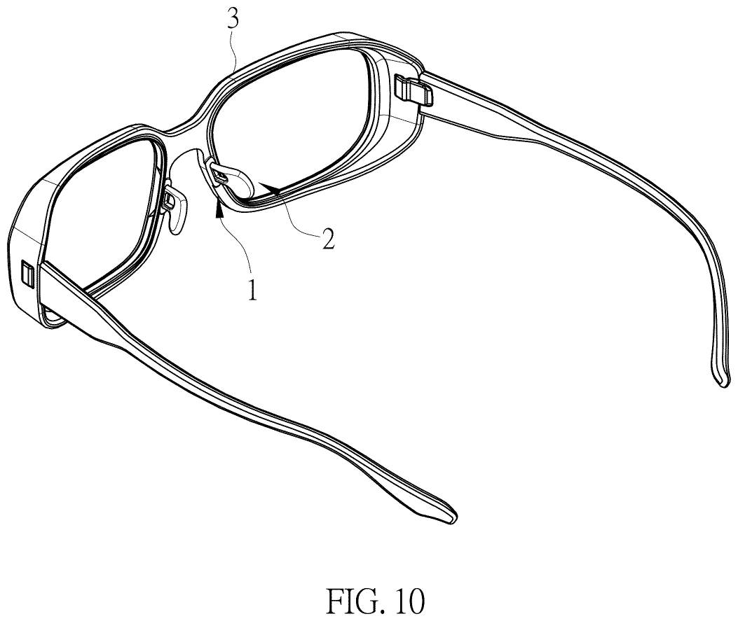

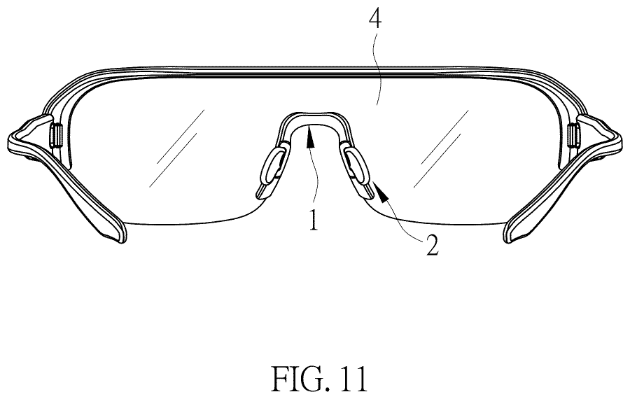

As described above, the present disclosure can be applied to different types of eyeglasses, such as full-frame eyeglasses, half-frame eyeglasses, sports and leisure eyeglasses, etc. Please refer to FIG. 10, which shows that the nose bridge holder 1 of the present disclosure is integrally formed with the frame 3. Of course, the nose bridge holder 1 can also be installed in the middle of a frame 3 in an assembled manner. Please refer to FIG. 11, which shows the application of the present disclosure in the aspect of leisure glasses. The leisure glasses are half-rim glasses, and the lens unit 4 is a single-piece lens. The nose bridge holder 1 is located at the lower edge of the middle section of the lens unit 4, and allows the lens unit 4 to be partially accommodated in the lens groove 14.

To sum up, the nose pad 2 of the present disclosure does not need to be locked with screws during the assembly process. During the process of detaching the nose pad 2, the nose pad 2 can be easily removed without the use of tools, thereby improving the convenience of replacing the nose pads 2 and allowing the eyeglasses to be used accordingly. According to needs or styling, the nose pads with different materials or colors can be replaced for use together. When one side of the nose pad is damaged, the nose pad on one side can be replaced separately, thereby helping to improve environmental benefits.

However, the above-mentioned embodiments are only illustrative to illustrate the effects of the present disclosure, and are not intended to limit the present disclosure. Those skilled in the art can make modifications and changes to the aforesaid embodiments without departing from the spirit and scope of the present disclosure. In addition, the numbers of elements in the above-mentioned embodiments are only for illustrative purposes, and are not intended to limit the present disclosure. Therefore, the scope of protection of rights of the present disclosure should be listed in the claims of the present disclosure below.

What is claimed is:

1. A pair of detachable nose pads, which is fitted to a glasses, wherein a side facing a face of a wearer is defined as an inner surface and a side facing outside is defined as an outer surface, the pair of detachable nose pads comprising:
a nose bridge holder having a spanning section and mounting sections extending downwardly from both ends of the spanning section and disposed correspondingly along both sides of a nose bridge of the wearer, wherein each of the mounting sections is provided with a slot, the slot has a retaining surface, and an inner surface of each of the mounting sections is provided with an insertion hole connected to the slot; and
two nose pads detachably embedded in each of the insertion holes, wherein each of the nose pads has a body that contacts with the wearer's nose to form a support, two brackets extend from one side of the body and penetrates through the insertion holes, the two brackets form an elastic space, a front end of each of the two brackets is radially projected with a snap button, a bottom of the snap button is fixed on a retaining surface of the slot, when each of the nose pads is detached or inserted into the insertion hole, each of the two brackets is deformed elastically by an external force into the elastic space such that the snap button is detached or forced into the slot.

2. The pair of detachable nose pads of claim 1, wherein each of the nose pads is provided with a reinforcing rib connected between the two brackets, and a stop portion is provided at a center of each of the insertion holes for the reinforcing rib to rest against and limit a position of the body with respect to each of the insertion holes.

3. The pair of detachable nose pads of claim 2, wherein when each of the brackets is embedded in each of the insertion holes, each of the reinforcing ribs is at least partially accommodated in each of the insertion holes.

4. The pair of detachable nose pads of claim 1, wherein a top of each of the snap buttons has a guiding surface in a tapered shape.

5. The pair of detachable nose pads of claim 1, wherein each of the slots has an opening through an outer surface of each of the mounting sections.

6. The pair of detachable nose pads of claim 1, wherein each of the insertion holes is in a form of an elongated strip.

7. The pair of detachable nose pads of claim 1, wherein the retaining surface is formed by one of walls of the slot.

8. The pair of detachable nose pads of claim 1, wherein the glasses includes a frame, and the nose bridge holder is assembled at a middle section of the frame or integrally molded with the frame.

9. The pair of detachable nose pads of claim 1, wherein the glasses comprises a lens unit, and the nose bridge holder is located at a lower edge of the middle section of the lens unit.

10. The pair of detachable nose pads of claim 1, wherein a recess is provided at a top of each of the snap buttons of each of the nose pads.

11. The pair of detachable nose pads of claim 1, further comprising two cushions, wherein each of the cushions has a neck extending from one side of each of the cushions, a plug is provided at an end of the neck, a peripheral edge of the plug is larger than a peripheral edge of the neck, the body of each of the nose pads has a corresponding through-hole, and each of the cushions is forced through the through-hole by the plug such that the cushions correspond to both sides of the wearer's nose.
